(19) United States
(12) Patent Application Publication
(10) Pub. No.: US 2023/0317331 A1
(43) Pub. Date: Oct. 5, 2023

(54) Magnetic Bead And Method For Producing Magnetic Bead

(71) Applicant: SEIKO EPSON CORPORATION, Tokyo (JP)

(72) Inventors: Sukenori ICHIKAWA, Suwa (JP); Akira ARAI, Shimosuwa (JP); Michio NAKAMORI, Matsumoto (JP)

(21) Appl. No.: 18/191,086

(22) Filed: Mar. 28, 2023

(30) Foreign Application Priority Data
Mar. 29, 2022 (JP) 2022-054377

(51) Int. Cl. H01F 1/153; B22F 1/16; B22F 1/05; B22F 9/08; B22F 1/08; B22F 1/07

(52) U.S. Cl. CPC H01F 1/15383; B22F 1/16; B22F 1/05; B22F 9/082; H01F 1/15308; B22F 1/08; B22F 1/07; B22F 2009/0828; B22F 2203/11; B22F 2301/35; B22F 2302/256

(57) ABSTRACT

A magnetic bead contains: a Fe-based magnetic metal powder; and a coating layer with which a particle surface of the Fe-based magnetic metal powder is coated. The Fe-based magnetic metal powder contains a crystal grain having a grain diameter of 1 nm or more and 60 nm or less in a ratio of 30% by volume or more and 100% by volume or less. In addition, the coating layer may contain an oxide and has an average thickness of 10 nm or more and 200 nm or less.

The present application is based on, and claims priority from JP Application Serial Number 2022-054377, filed Mar. 29, 2022, the disclosure of which is hereby incorporated by reference herein in its entirety.

### BACKGROUND

### 1. Technical Field

The present disclosure relates to a magnetic bead and a method for producing a magnetic bead.

### 2. Related Art

In recent years, in a diagnosis in the medical field and in the field of life science, there is an increasing demand for testing biological substances. Among biological substance testing methods, a polymerase chain reaction (PCR) method is a method of extracting a nucleic acid such as DNA or RNA, and specifically amplifying and detecting the nucleic acid. In a process of testing such a biological substance, first, it is necessary to extract a substance to be tested from a specimen.

For example, JP-A-2005-348738 discloses an RNA extraction method including: a step of mixing a nucleic-acid-binding solid phase containing ethyl lactate, a chaotropic agent, and silicon oxide with a biological substance containing RNA so as to selectively bind the RNA to the solid phase; a step of separating the solid phase bound with the RNA from a liquid phase; a step of washing the solid phase; and a step of eluting the RNA from the solid phase. In this RNA extraction method, in a mixed solution composed of the biological substance containing the RNA, ethyl lactate, and the chaotropic agent, a concentration of the chaotropic agent is 1.0 mol/1 to 4.0 mol/1 and a concentration of ethyl lactate in the mixed solution is 20% to 40%. Accordingly, the RNA can be extracted with high purity.

On the other hand, a magnetic separation method using magnetic beads is widely used for such biological substance extraction. In the magnetic separation method, a biological substance to be extracted is extracted by applying a magnetic field by using magnetic beads having a function of carrying the biological substance. Specifically, after the magnetic beads having the function of carrying the substance to be tested on surfaces thereof are dispersed in a dispersion medium, an obtained dispersion liquid is attached to a magnetic field generating device such as a magnetic stand, and ON and OFF of magnetic field application are repeated a plurality of times. Accordingly, the substance to be tested is extracted. Since such a magnetic separation method is a method of separating and collecting the magnetic beads by a magnetic force, a separation operation can be performed rapidly.

In the RNA extraction method, a mixed solution containing a biological substance may be acidified. In this case, when the magnetic separation method is used to extract RNA, deterioration such as oxidation or corrosion of the magnetic beads may occur. When the magnetic beads deteriorate, a metal element of the magnetic beads may be eluted into an eluent, and thus testing accuracy of the extracted biological substance may be reduced. Therefore, it is an object to improve the testing accuracy of the extracted biological substance by improving corrosion resistance of the magnetic beads while maintaining magnetic separation performance of the magnetic beads.

### SUMMARY

A magnetic bead according to an application example of the present disclosure contains:
a Fe-based magnetic metal powder; and
a coating layer with which a particle surface of the Fe-based magnetic metal powder is coated, in which
the Fe-based magnetic metal powder contains a crystal grain having a grain diameter of 1 nm or more and 60 nm or less in a ratio of 30% by volume or more and 100% by volume or less.

A method for producing a magnetic bead according to an application example of the present disclosure is a method for producing a magnetic bead containing a Fe-based magnetic metal powder, the method including:
producing a Fe-based amorphous metal powder by a water atomization method or a rotary water atomization method; and
subjecting the Fe-based amorphous metal powder to a heat treatment at a temperature of 520° C. or higher and 640° C. or lower to precipitate a crystal grain having a grain diameter of 1 nm or more and 60 nm or less in a ratio of 30% by volume or more and 100% by volume or less.

### BRIEF DESCRIPTION OF THE DRAWINGS

FIG. 1 is a process diagram showing an example of a biological substance extraction method.

FIG. 2 is a schematic diagram showing the biological substance extraction method shown in FIG. 1.

FIG. 3 is a schematic diagram showing the biological substance extraction method shown in FIG. 1.

FIG. 4 is a schematic diagram showing the biological substance extraction method shown in FIG. 1.

FIG. 5 is a cross-sectional view showing a magnetic bead according to an embodiment.

FIG. 6 is a cross-sectional view showing a modification of the magnetic bead in FIG. 5.

FIG. 7 is a process diagram showing a method for producing the magnetic bead according to the embodiment.

### DESCRIPTION OF EXEMPLARY EMBODIMENTS

Hereinafter, preferred embodiments of a magnetic bead and a method for producing a magnetic bead according to the present disclosure will be described in detail with reference to the accompanying drawings.

The magnetic beads according to the embodiment are a particle group that adsorbs a biological substance and are used for magnetic separation in this state. The magnetic separation is a technique of applying an external magnetic field to a container in which a solid phase containing magnetic beads and a liquid phase containing a dispersion medium are charged and magnetically attracting the solid phase so as to separate the solid phase and the liquid phase from each other.

Examples of the biological substance include substances such as nucleic acids (such as DNA and RNA), proteins, saccharides, various cells (such as cancer cells), peptides, bacteria, and viruses. The nucleic acid may exist in a state of being contained in, for example, a biological sample such as a cell or a biological tissue, a virus, or a bacterium. When such a biological substance is extracted through, for example, steps of dissolution/adsorption, washing, and elution, the biological substance can be purified and extracted by using the above-described magnetic separation.

### 1. Biological Substance Extraction Method

Hereinafter, an example of a biological substance extraction method using magnetic separation will be described. In the following description, a case where the biological substance is a nucleic acid will be described as an example.

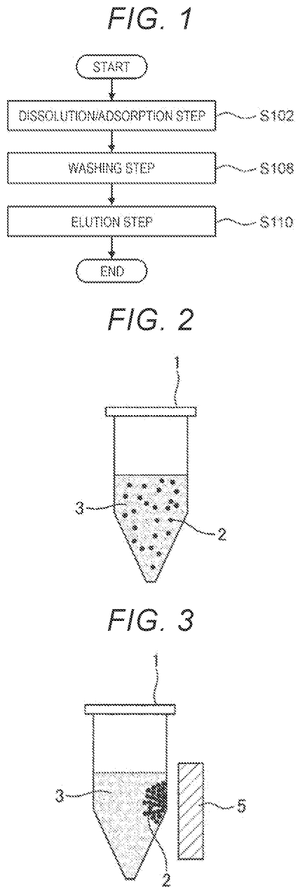

FIG. 1 is a process diagram showing an example of the biological substance extraction method. FIGS. 2 to 4 are schematic diagrams showing the biological substance extraction method shown in FIG. 1.

The biological substance extraction method shown in FIG. 1 includes a dissolution/adsorption step S102, a washing step S108, and an elution step S110. Hereinafter, each step will be sequentially described.

### 1.1. Dissolution/Adsorption Step

In the dissolution/adsorption step S102, a specimen sample containing a nucleic acid, a dissolution and adsorption liquid, and magnetic beads 2 are charged in a container 1 shown in FIG. 2. Then, the materials contained in the container 1 are mixed. Accordingly, as shown in FIG. 2, the magnetic beads 2 are dispersed again in a liquid 3 in the container 1. Since the nucleic acid is usually encapsulated in a cell membrane or a nucleus, a so-called outer shell of the cell membrane or the nucleus is first dissolved and removed by a dissolution action of the dissolution and adsorption solution, and the nucleic acid is extracted. Thereafter, the nucleic acid is adsorbed by the magnetic beads 2 due to an adsorption action of the dissolution and adsorption liquid.

As the dissolution and adsorption liquid, for example, a liquid containing a chaotropic substance is used. The chaotropic substance acts to generate chaotropic ions in an aqueous solution and reduce interaction of water molecules, thereby destabilizing a structure, and contributes to the adsorption of the nucleic acid to the magnetic beads 2.

Among nucleic acids, particularly when RNA is extracted, it is preferable to acidify the liquid 3 in the container 1 by adding an acid or the like. Since an RNA monomer contains ribose, the RNA monomer is more easily dissolved in a polar solvent than DNA. When RNA and DNA are separated from each other by using this difference, after the outer shell is dissolved and removed, for example, an acid may be added to acidify the liquid 3. Thereafter, a non-polar solvent such as phenol or chloroform is added to the liquid 3. Accordingly, the DNA migrates to the non-polar solvent, whereas the RNA remains in the polar solvent. As a result, the RNA and the DNA can be separated from each other and the RNA can be extracted.

When the RNA is extracted, the pH of the liquid 3 in the container 1 is preferably 5.0 or less, and more preferably 2.0 or more and 4.0 or less. Accordingly, ionization equilibrium of phosphate groups contained in the RNA is biased toward hydroxy groups, so that the RNA is particularly easily dissolved in the polar solvent. Therefore, RNA extraction efficiency can be further improved.

### 1.1.1. Magnetic Separation Operation

In the dissolution/adsorption step S102, an external magnetic field is applied to the magnetic beads 2 to which the nucleic acid is adsorbed, and the magnetic beads 2 are magnetically attracted. Accordingly, the magnetic beads 2 are moved and fixed to an inner wall of the container 1. As a result, as shown in FIG. 3, the magnetic beads 2 that are in a solid phase and the liquid 3 that is in a liquid phase can be separated from each other. In the present specification, an operation of fixing the magnetic beads 2 by applying such an external magnetic field is referred to as a “magnetic separation operation”.

Before the magnetic separation operation is performed, the materials contained in the container 1 are stirred as necessary. Accordingly, a probability that the nucleic acid is adsorbed to the magnetic beads 2 is increased. For example, a vortex mixer, manual shaking or pipetting is used to perform the stirring.

For example, a magnet 5 disposed beside the container is used to apply the external magnetic field. The magnet 5 may be an electromagnet or a permanent magnet. When the external magnetic field acts on the magnetic beads 2, the magnetic beads 2 move toward the magnet 5.

After the magnetic separation operation is performed, acceleration may be applied to the container as necessary. Accordingly, the liquid 3 adhering to the magnetic beads 2 can be shaken off, so that the liquid 3 that is not separated can be reduced. The acceleration may be centrifugal acceleration. A centrifuge may be used to apply the centrifugal acceleration.

### 1.1.2. Liquid Discharge Operation

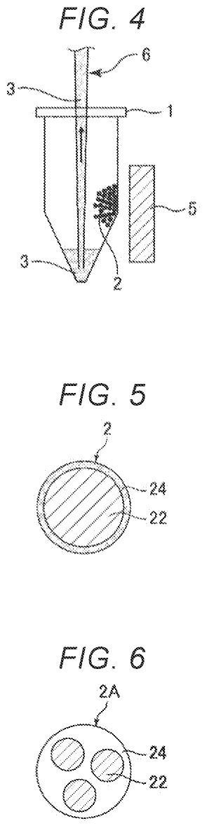

In the dissolution/adsorption step S102, in a state in which the magnetic beads 2 are fixed to the inner wall of the container 1, as shown in FIG. 4, the liquid 3 accumulated on a bottom of the container 1 is suctioned and discharged by, for example, a pipette 6. In the present specification, such an operation of discharging the liquid 3 is referred to as a “liquid discharge operation”.

### 1.2. Washing Step

In the washing step S108, the magnetic beads 2 to which the nucleic acid is adsorbed are washed. Washing refers to an operation of removing impurities by bringing the magnetic beads 2 to which the nucleic acid is adsorbed into contact with a washing liquid and then separating the magnetic beads 2 again in order to remove the impurities adsorbed on the magnetic beads 2.

Specifically, after the washing liquid is charged in the container 1 in which the magnetic beads 2 to which the nucleic acid is adsorbed are charged, the magnetic separation operation and the liquid discharge operation described above are performed again.

Among these operations, in the magnetic separation operation, first, the washing liquid is supplied into the container 1 by a pipette or the like. Then, the magnetic beads 2 and the washing liquid are stirred. Accordingly, the washing liquid is in contact with the magnetic beads 2, and the magnetic beads 2 to which the nucleic acid is adsorbed are washed. For example, a vortex mixer, manual shaking or pipetting is used to perform the stirring. In addition, at this time, the application of the external magnetic field may be temporarily turned off. Accordingly, the magnetic beads 2 are dispersed in the washing liquid, so that washing efficiency can be further improved.

Next, as the liquid discharge operation, the washing liquid accumulated on the bottom of the container 1 is discharged in a state in which the magnetic beads 2 are fixed to the inner wall of the container 1. The magnetic beads 2 are washed by performing the supply and discharge of the washing liquid as described above at least once. Accordingly, impurities excluding the nucleic acid can be removed with high accuracy.

The washing liquid is not particularly limited as long as the washing liquid is a liquid that does not promote elution of the nucleic acid and does not promote binding of impurities to the magnetic beads 2, and examples thereof include organic solvents such as ethanol, isopropyl alcohol, and acetone, and aqueous solutions and low salt concentration aqueous solutions of these organic solvents.

The washing liquid may contain a surfactant such as Triton (registered trademark), Tween (registered trademark), or SDS. In addition, the washing liquid may contain a chaotropic substance such as guanidine hydrochloride.

In addition, the washing step S108 may be performed as necessary, and may be omitted when washing is not necessary.

### 1.3. Elution Step

In the elution step S110, the nucleic acid adsorbed on the magnetic beads 2 is eluted into an eluent. Elution is an operation of transferring the nucleic acid to the eluent by bringing the magnetic beads 2 to which the nucleic acid is adsorbed into contact with the eluent and then separating the magnetic beads 2 again.

Specifically, after the eluent is charged in the container 1 in which the magnetic beads 2 to which the nucleic acid is adsorbed are charged, the magnetic separation operation and the liquid discharge operation described above are performed again.

Among these operations, in the magnetic separation operation, first, the eluent is supplied into the container 1 by a pipette or the like. Then, the magnetic beads 2 and the eluent are stirred. Accordingly, the eluent is in contact with the magnetic beads 2, and the nucleic acid is eluted into the eluent. For example, a vortex mixer, manual shaking or pipetting is used to perform the stirring. In addition, at this time, the application of the external magnetic field may be temporarily turned off. Accordingly, the magnetic beads 2 are dispersed in the eluent, so that elution efficiency can be further improved.

Next, as the liquid discharge operation, the eluent accumulated on the bottom of the container 1 is discharged in a state in which the magnetic beads 2 are fixed to the inner wall of the container 1. Accordingly, the eluent containing the nucleic acid can be collected.

The eluent is not particularly limited as long as the eluent is a liquid that promotes the elution of the nucleic acid from the magnetic beads 2 to which the nucleic acid is adsorbed, and for example, in addition to water such as sterile water or pure water, a TE buffer, that is, an aqueous solution containing 10 mM of Tris-HCl buffer and 1 mM of EDTA and having pH of about 8 is preferably used.

The eluent may contain a surfactant such as Triton (registered trademark), Tween (registered trademark), or SDS. In addition, sodium azide may be contained as a preservative.

In addition, in the elution step S110, the eluent may be heated. Accordingly, the elution of the nucleic acid can be promoted. A heating temperature of the eluent is not particularly limited, and is preferably 70° C. or higher and 200° C. or lower, more preferably 80° C. or higher and 150° C. or lower, and still more preferably 95° C. or higher and 125° C. or lower.

### 2. Magnetic Bead

Next, the magnetic beads 2 according to the embodiment will be described. The magnetic beads 2 are particles that are magnetic and whose surfaces are bindable to a biological substance.

FIG. 5 is a cross-sectional view showing one magnetic bead 2 according to the embodiment. The magnetic bead 2 shown in FIG. 5 contains a magnetic metal powder 22 and a coating layer 24. As the magnetic metal powder 22, a metal powder having magnetic properties is used. At least a surface of the coating layer 24 is formed of a substance or a chemical structure bindable to the biological substance. In the above-described magnetic separation operation, a particle group that is an aggregate of the magnetic beads 2 is used. In the present specification, the magnetic bead 2 refers to a particle group or one particle constituting the particle group.

Saturation magnetization of the magnetic bead 2 is preferably 50 emu/g or more, and more preferably 100 emu/g or more. The saturation magnetization is a value of magnetization in a case where magnetization exhibited by a magnetic material when a sufficiently large magnetic field is applied from outside is constant regardless of the magnetic field. As the saturation magnetization of the magnetic bead 2 becomes higher, a function thereof as a magnetic material can be exhibited more sufficiently. Specifically, since a moving speed of the magnetic bead 2 in a magnetic field can be increased, a time required for the magnetic separation can be shortened. In addition, the saturation magnetization of the magnetic bead 2 affects an adsorption force when the magnetic bead 2 is fixed by the external magnetic field. When the saturation magnetization is within the above range, a sufficiently high adsorption force can be obtained, and therefore, when the liquid 3 is discharged in a state in which the magnetic bead 2 is fixed, discharge of the magnetic bead 2 together with the liquid 3 can be prevented. Accordingly, it is possible to prevent a decrease in yield of the nucleic acid caused by a decrease in amount of the magnetic bead 2.

An upper limit value of the saturation magnetization of the magnetic bead 2 is not particularly limited, and is preferably 220 emu/g or less from the viewpoint of ease of material selection suitable for balancing performance and cost.

The saturation magnetization of the magnetic bead 2 can be measured by a vibrating sample magnetometer (VSM) or the like. Examples of the vibrating sample magnetometer include TM-VSM1230-MHHL manufactured by TAMAKAWA CO., LTD. A maximum applied magnetic field at the time of measuring the saturation magnetization is, for example, 0.5 T or more.

In addition, an average particle diameter D50 of the magnetic bead 2 is preferably 0.1 μm or more and 100 μm or less, more preferably 0.5 μm or more and 50 μm or less, still more preferably 1 μm or more and 30 μm or less, and particularly preferably 2 μm or more and 20 μm or less. When the average particle diameter D50 of the magnetic bead 2 is within the above range, a specific surface area of the magnetic bead 2 can be sufficiently large, and thus an attractive force and an adsorption force suitable for magnetic separation can be generated in the magnetic bead 2. In addition, aggregation of the magnetic beads 2 can be reduced, and thus dispersibility can be improved. When the average particle diameter D50 of the magnetic bead 2 is less than the lower limit value, a value of magnetization of the magnetic bead 2 is small, the magnetic beads 2 are likely to aggregate, and, as a result, extraction efficiency of the biological substance may decrease. In addition, the moving speed of the magnetic bead 2 may decrease, and the time required for magnetic separation may increase. On the other hand, when the average particle diameter D50 of the magnetic bead 2 exceeds the upper limit value, the specific surface area of the magnetic bead 2 is small, so that a sufficient amount of the nucleic acid cannot be adsorbed, and thus an amount of the extracted nucleic acid may decrease. In addition, the magnetic bead 2 may easily settle, the amount of the magnetic bead 2 that can contribute to the extraction of the nucleic acid may decrease, and thus the extraction efficiency of the nucleic acid may decrease.

A volume-based particle size distribution may be measured by a laser diffraction/dispersion method, and the average particle diameter D50 of the magnetic bead 2 can be obtained based on an integrated distribution curve obtained based on the particle size distribution. Specifically, in the integrated distribution curve, a particle diameter (median diameter) at which a cumulative value is 50% from a small diameter side is the average particle diameter D50 of the magnetic bead 2. Examples of a device for measuring the particle size distribution by the laser diffraction/dispersion method include MT3300 series manufactured by MicrotracBEL Corporation. The method is not limited to the laser diffraction/dispersion method, and a method such as image analysis may be used.

In addition, a 90% particle diameter of the magnetic bead 2 is referred to as D90. In the magnetic bead 2, a ratio D90/D50 of the 90% particle diameter D90 to the average particle diameter D50 is preferably 3.00 or less, more preferably 2.00 or less, and still more preferably 1.75 or less. Accordingly, since a content of coarse particles is low, it is possible to prevent the coarse particles from attracting and aggregating relatively small surrounding particles and thus forming aggregates. When aggregates are generated, the aggregates precipitate due to own weight, and the extraction efficiency may decrease and a testing time of the biological substance may increase accordingly. Therefore, when the ratio D90/D50 is within the above range, occurrence of these problems can be prevented. When the ratio D90/D50 exceeds the upper limit value, the content of coarse particles is high, and therefore, even when the application of the external magnetic field is turned off, the dispersibility of the magnetic bead 2 may decrease, and aggregation may easily occur.

The volume-based particle size distribution may be measured by the laser diffraction/dispersion method, and the 90% particle diameter D90 of the magnetic bead 2 can be obtained based on the integrated distribution curve obtained based on the particle size distribution. Specifically, in the integrated distribution curve, a particle diameter at which a cumulative value is 90% from the small diameter side is the 90% particle diameter D90 of the magnetic bead 2. Examples of a device for measuring the particle size distribution by the laser diffraction/dispersion method include MT3300 series manufactured by MicrotracBEL Corporation. The method is not limited to the laser diffraction/dispersion method, and a method such as image analysis may be used.

In addition, when an average thickness of the coating layer 24 is t and the average particle diameter of the magnetic bead 2 is D50, a ratio t/D50 of t to D50 is preferably 0.0001 or more and 0.05 or less, and more preferably 0.001 or more and 0.01 or less. When the t/D50 is less than the lower limit value, a ratio of a thickness of the coating layer 24 to a size of the magnetic metal powder 22 is excessively small, so that the coating layer 24 may be broken or peeled off when the magnetic beads 2 collide with each other or the magnetic bead 2 collides with the inner wall of the container 1 or the like. Therefore, the amount of the extracted nucleic acid adsorbed on the surface of the coating layer 24 may decrease, and thus the extraction efficiency may decrease. In addition, fragments of the peeled coating layer 24 and the magnetic metal powder 22 are present in the dispersion, and may be mixed as impurities (contamination) at the same time when the nucleic acid is extracted. Further, the magnetic metal powder 22 is exposed due to breaking and peeling of the coating layer 24, and elution of iron ions or the like occurs in a case where the magnetic metal powder 22 is brought into contact with an acidic solution or the like, and, as a result, the extraction efficiency of the nucleic acid may decrease. On the other hand, when the t/D50 exceeds the upper limit value, a volume ratio of the coating layer 24 to the entire volume of the magnetic bead 2 is large, and thus magnetization per volume of the magnetic bead 2 may decrease. Accordingly, the moving speed of the magnetic bead 2 when the external magnetic field acts thereon decreases, and the time required for magnetic separation may increase.

The thickness of the coating layer 24 can be measured, for example, based on a cross-sectional observation image of the magnetic bead 2 observed with a transmission electron microscope or a scanning electron microscope. In addition, the average thickness t of the coating layer 24 can be calculated by acquiring a plurality of observation images and averaging measured values based on image processing or the like. For example, the average thickness t is a value obtained by measuring the thickness of the coating layer 24 at five or more locations on one magnetic bead 2, obtaining an average value of the thickness, and then averaging the average values of ten or more magnetic beads 2. In addition, for example, intensities of a Si—K characteristic X-ray and a Fe-L characteristic X-ray may be compared by an analyzer of energy dispersive X-ray spectroscopy (EDX) or the like, and the thickness of the coating layer 24 may be calculated based on a result of the comparison. That is, as described later, in a case where the coating layer 24 contains silicon and the magnetic metal powder 22 is composed of a Fe-based alloy, an intensity ratio of a Si—K characteristic X-ray derived from the coating layer 24 to a sum of a Fe-L characteristic X-ray derived from the magnetic metal powder 22 and the Si—K characteristic X-ray derived from the coating layer 24 can be converted into the thickness of the coating layer 24.

In addition, a coercive force Hc of the magnetic bead 2 is preferably 1500 A/m or less, more preferably 800 A/m or less, and still more preferably 400 A/m or less. The coercive force Hc refers to a value of an external magnetic field in an opposite direction required to return a magnetized magnetic material to an unmagnetized state. That is, the coercive force Hc means a resistance force against an external magnetic field. As the coercive force Hc of the magnetic bead 2 becomes smaller, the magnetic beads 2 are less likely to aggregate even when a state thereof is switched from a state in which the magnetic field is applied to a state in which the magnetic field is not applied, and thus the magnetic bead 2 can be uniformly dispersed in the dispersion liquid. Further, even when the switching of the magnetic field application is repeated, as the coercive force Hc becomes smaller, redispersibility of the magnetic bead 2 is more excellent, so that aggregation of the magnetic beads 2 can be further reduced. A lower limit value of the coercive force Hc of the magnetic bead 2 is not particularly limited, and is preferably 5 A/m or more from the viewpoint of ease of material selection suitable for balancing performance and cost.

The coercive force Hc of the magnetic bead can be measured by a vibrating sample magnetometer or the like in the same manner as the saturation magnetization described above. A maximum applied magnetic field at the time of measuring the coercive force Hc is, for example, 15 kOe.

In addition, a relative permeability of the magnetic bead 2 is preferably 5 or more. When the relative permeability of the magnetic bead 2 is less than the lower limit value, the moving speed of the magnetic bead 2 may decrease, and the time required for magnetic separation may increase. The upper limit value of the relative permeability of the magnetic bead 2 is not particularly limited, and a value of the relative permeability is often substantially 100 or less due to an influence of an antimagnetic field since the magnetic bead 2 is in a powder form.

### 2.1. Magnetic Metal Powder

The magnetic metal powder 22 is a Fe-based magnetic metal powder composed of a Fe-based alloy. To be Fe-based means that a content of Fe is highest in terms of atomic ratio. The Fe content in the Fe-based alloy is preferably 50 atom % or more, and more preferably 70 atom % or more. Such a Fe-based alloy implements the magnetic metal powder 22 having high saturation magnetization and high magnetic permeability even when a particle diameter is small. Accordingly, it is possible to implement the magnetic beads 2 having a high moving speed due to the action of the external magnetic field and having a large magnetic attractive force when captured by the external magnetic field. As a result, the time required for magnetic separation can be shortened, and the magnetic bead 2 can be prevented from being mixed into the eluent and becoming impurities.

The magnetic metal powder 22 contains a crystal grain having a grain diameter of 1 nm or more and 60 nm or less in a ratio of 30% by volume or more and 100% by volume or less. Hereinafter, a crystal whose grain diameter is in the grain diameter range described above is also referred to as a “nanocrystal”. Since the nanocrystal is minute, a magnetocrystalline anisotropy in the nanocrystal is likely to be averaged in each particle of the magnetic metal powder 22. Therefore, a coercive force of the magnetic metal powder 22 can be reduced, and thus a magnetically soft powder can be obtained. When the volume ratio occupied by such a nanocrystal is within the above range, the coercive force of the magnetic metal powder 22 can be sufficiently reduced. When the volume ratio occupied by the nanocrystal is controlled within the above range, saturation magnetization of the magnetic metal powder 22 can be increased without impairing the low coercive force. Such a magnetic metal powder 22 has both a low coercive force and high saturation magnetization, and contributes to implementation of the magnetic beads 2 that have both excellent redispersibility and excellent magnetic separation performance in a liquid.

In addition, the nanocrystal further improve corrosion resistance of the magnetic metal powder 22 as compared with a coarse crystal, that is, a crystal grain or amorphous structure whose grain diameter is larger than the grain diameter range described above. As one of reasons for this, it is considered that a corrosion reaction such as oxidation of iron hardly proceeds due to a complex and high-density crystal grain boundary generated by the nanocrystal. Therefore, even when the magnetic metal powder 22 in which the volume ratio of the nanocrystal is within the above range is immersed in, for example, an acidic liquid, oxidation or corrosion is less likely to occur, and elution of iron ions is reduced. When iron ions are eluted, the action of the chaotropic substance described above in the dissolution/adsorption step S102 is inhibited, and adsorption of RNA and DNA on the surfaces of the magnetic bead 2 is inhibited. Therefore, by reducing the elution of iron ions, it is possible to prevent a decrease in adsorption efficiency of RNA and DNA. In addition, it is also possible to prevent iron ions from affecting testing of RNA and DNA.

The volume ratio of the nanocrystal is preferably 40% by volume or more and 99% by volume or less, and more preferably 60% by volume or more and 95% by volume or less. When the volume ratio of the nanocrystal is less than the lower limit value, depending on a composition of the Fe-based alloy, the coercive force of the magnetic metal powder 22 may not be sufficiently reduced, and the saturation magnetization may not be sufficiently increased. On the other hand, although the volume ratio of the nanocrystal may exceed the upper limit value, depending on the composition of the Fe-based alloy, toughness of particles of the magnetic metal powder 22 may decrease and difficulty in producing the magnetic metal powder 22 may increase.

In addition, when the volume ratio of the nanocrystal is less than 100% by volume, amorphous (amorphous structure) may be contained together with the nanocrystal. The term “amorphous” refers to a structure having a grain diameter of less than 1 nm. Since the amorphous is excellent in toughness, it is possible to increase the toughness of the particles of the magnetic metal powder 22 by containing the amorphous in a volume ratio smaller than that of the nanocrystal. The volume ratio of the amorphous is not particularly limited, and is preferably 70% by volume or less, more preferably 1% by volume or more and 60% by volume or less, and still more preferably 5% by volume or more and 40% by volume or less.

The grain diameter of the crystal grain can be read based on, for example, an observation image obtained by observing a cross section of the particle of the magnetic metal powder 22 with a transmission electron microscope. In addition, the grain diameter of the crystal grain can also be estimated by the Scherrer method based on a diffraction peak of a crystal phase in a diffraction pattern obtained by an X-ray diffraction method. In addition, the volume ratio of the nanocrystal or the amorphous is obtained by a method in which an area ratio occupied by the nanocrystal or the amorphous in an observation image is obtained and the area ratio is regarded as the volume ratio. A calculation target region may have a width of 100 nm square or more.

The Fe-based alloy is preferably an alloy having a composition represented by a composition formula Fe_{100-a-b-c-d-e}CuₐSi_{b}B_{c}Nb_{d}Mₑ. M in the composition formula is V, Cr, Mn, Al, a platinum group element, Sc, Y, Au, Zn, Sn, or Re. In addition, in the composition formula, 0≤a≤3.0, 0<b≤30.0, 0≤c≤25.0, 0≤d≤30.0, and 0≤e≤10.0, and a, b, c, d, and e represent an atomic percentage of each element.

When the Fe-based alloy has the composition represented by the composition formula, the Fe-based alloy is particularly excellent in low coercive force and high saturation magnetization. Therefore, the magnetic metal powder 22 composed of the Fe-based alloy contributes to the implementation of the magnetic bead 2 having a low coercive force and high saturation magnetization.

Hereinafter, each component of the composition formula will be described.

Fe (iron) greatly affects basic magnetic properties and mechanical properties of the magnetic metal powder 22.

Cu (copper) tends to separate from Fe when the magnetic metal powder 22 is produced from a raw material. Therefore, since Cu is contained, the composition fluctuates, and a region prone to crystallization is generated partially in a particle. As a result, precipitation of a Fe phase of a body-centered cubic lattice, which is relatively prone to crystallization, is promoted, and the nanocrystal is easily formed.

The content a of Cu is 0 atom % or more and 3.0 atom % or less, preferably 0.5 atom % or more and 2.0 atom % or less, and more preferably 0.7 atom % or more and 1.5 atom % or less. When the content a of Cu is less than the lower limit value, depending on the composition of the Fe-based alloy, micronization of crystal grains may become difficult and nanocrystals may not be sufficiently formed. On the other hand, when the content a of Cu exceeds the upper limit value, depending on the composition of the Fe-based alloy, the saturation magnetization of the magnetic metal powder 22 may decrease, and the mechanical properties and the corrosion resistance may decrease.

Si (silicon) promotes amorphization when the magnetic metal powder 22 is produced from the raw material. Then, the formed powder containing the amorphous is subjected to a heat treatment to form nanocrystals having a more uniform grain diameter. Therefore, by containing Si, the volume ratio of the nanocrystal can be particularly increased.

The content b of Si is more than 0 atom % and 30.0 atom % or less, preferably 5.0 atom % or more and 20.0 atom % or less, and more preferably 7.0 atom % or more and 15.0 atom % or less. When the content b of Si is less than the lower limit value, depending on the composition of the Fe-based alloy, amorphization at the time of production may be insufficient and thus the volume ratio of the nanocrystal may decrease. On the other hand, when the content b of Si exceeds the upper limit value, depending on the composition of the Fe-based alloy, the saturation magnetization of the magnetic metal powder 22 may decrease, and the mechanical properties and the corrosion resistance may decrease.

B (boron) promotes amorphization when the magnetic metal powder 22 is produced from the raw material. Then, the formed powder containing the amorphous is subjected to a heat treatment to form nanocrystals having a more uniform grain diameter. Therefore, by containing B, the volume ratio of the nanocrystal can be particularly increased. In addition, by using Si and B in combination, amorphization can be synergistically promoted based on an atomic radius difference therebetween, and thus the formation of the nanocrystal is particularly promoted.

The content c of B is 0 atom % or more and 25.0 atom % or less, preferably 1.0 atom % or more and 15.0 atom % or less, and more preferably 1.5 atom % or more and 13.0 atom % or less. When the content c of B is less than the lower limit value, depending on the composition of the Fe-based alloy, amorphization at the time of production may be insufficient and thus the volume ratio of the nanocrystal may decrease. On the other hand, when the content c of B exceeds the upper limit value, depending on the composition of the Fe-based alloy, the saturation magnetization of the magnetic metal powder 22 may decrease, and the mechanical properties and the corrosion resistance may decrease.

In addition, a sum of the Si content and the B content is preferably 5.0 atom % or more and 30.0 atom % or less, more preferably 8.0 atom % or more and 27.0 atom % or less, and still more preferably 9.0 atom % or more and 24.0 atom % or less.

Nb (niobium) contributes to micronization of crystal grains together with Cu. Therefore, by containing Nb, the nanocrystal is particularly easily formed.

The content d of Nb is 0 atom % or more and 30.0 atom % or less, preferably 2.0 atom % or more and 10.0 atom % or less, and more preferably 2.5 atom % or more and 8.0 atom % or less. When the content d of Nb is less than the lower limit value, depending on the composition of the Fe-based alloy, the micronization of crystal grains may become difficult and the nanocrystal may not be sufficiently formed. On the other hand, when the content d of Nd exceeds the upper limit value, the saturation magnetization of the magnetic metal powder 22 may decrease, and the mechanical properties may decrease.

M is at least one element selected from the group consisting of V, Cr, Mn, Al, platinum group elements, Sc, Y, Au, Zn, Sn, and Re. Such M improves the magnetic properties of the magnetic metal powder 22 and particularly improves the corrosion resistance. The platinum group elements refer to six elements belonging to the fifth period and the sixth period and belonging to the eighth group, the ninth group, and the tenth group in the periodic table, and specifically refers to at least one element among Ru, Rh, Pd, Os, Ir, and Pt.

The content e of M is 0 atom % or more and 10.0 atom % or less, preferably 0.1 atom % or more and 5.0 atom % or less, and more preferably 0.3 atom % or more and 3.0 atom % or less. Although the content e of M may be less than the lower limit value, the above-described effects may not be sufficiently obtained. On the other hand, when the content e of M exceeds the upper limit value, the saturation magnetization may decrease and the corrosion resistance may decrease.

In addition, M preferably contains Cr in particular. Cr contributes to particularly improving the corrosion resistance of the magnetic metal powder 22.

The Fe-based alloy may contain impurities as long as the effects of the magnetic metal powder 22 are not impaired. The impurities in the embodiment are elements that are unintentionally mixed in the raw material of the magnetic metal powder 22 or mixed at the time of producing the magnetic bead 2. The impurities are not particularly limited, and examples thereof include all elements other than the above-described elements.

A total content of the impurities is preferably 1.0 atom % or less. At this level, even if the impurities are contained, the effects of the magnetic metal powder 22 are less likely to be impaired.

The constituent elements and composition of the magnetic metal powder 22 can be identified by an ICP emission spectrometric method defined in JIS G 1258:2014, a spark emission spectrometric method defined in JIS G 1253:2002, or the like. In addition, when the magnetic metal powder 22 is coated with the coating layer 24, the constituent elements and composition can be measured by the above method after the coating layer 24 is removed by a chemical or physical method. In addition, when it is difficult to remove the coating layer 24, for example, after the magnetic bead 2 is cut, a portion of the magnetic metal powder 22 as a core can be analyzed by an analysis device such as an electron probe micro analyzer (EPMA) or energy dispersive X-ray spectroscopy (EDX).

A Vickers hardness of the magnetic metal powder 22 is preferably 100 or more, more preferably 300 or more, and still more preferably 800 or more. A method for measuring the hardness of the magnetic metal powder 22 is, for example, as follows. A plurality of particles of the magnetic metal powder 22 are taken out and embedded in a resin to prepare a resin-embedded sample, and then a cross section of the magnetic metal powder 22 is caused to appear on a surface of the resin-embedded sample by grinding and polishing. An indentation is made on the resin-embedded sample by using a micro Vickers tester, a nanoindenter, or the like, and the hardness is measured based on a size of the indentation.

When the Vickers hardness of the magnetic metal powder 22 is less than the lower limit value, the magnetic metal powder 22 may be plastically deformed due to an impact when the magnetic beads 2 collide with each other. When the plastic deformation occurs, the coating layer 24 may peel off or fall off. The upper limit of the Vickers hardness is not particularly limited, and is preferably 3000 or less from the viewpoint of ease of material selection suitable for balancing performance and cost.

### 2.2. Coating Layer

As shown in FIG. 5, a particle surface of the magnetic metal powder 22 is coated with the coating layer 24. The coating layer 24 may be formed on at least a part of the particle surface of the magnetic metal powder 22, and preferably covers the entire particle surface.

Main functions of the coating layer 24 are to adsorb the biological substance and to prevent exposure of the particle of the magnetic metal powder 22 so as to improve the corrosion resistance. From this viewpoint, the coating layer 24 may contain the following substance or chemical structure on the surface thereof.

A first preferable substance constituting the coating layer 24 is an oxide such as a silicon oxide. The silicon oxide is a substance particularly suitable for nucleic acid extraction, and a composition formula thereof is preferably, for example, SiOₓ (0<x≤2), and specifically SiO₂ is preferable. The silicon oxide enables extraction and collection of the nucleic acid by specifically adsorbing the nucleic acid in an aqueous solution containing a chaotropic substance. In addition to the silicon oxide, examples of the oxide include a composite oxide or a composite containing silicon and one or two or more selected from the group consisting of Al, Ti, V, Nb, Cr, Mn, Sn, and Zr.

In addition, these oxides are excellent in resistance in, for example, an acidic solution. Therefore, the coating layer 24 containing these oxides can effectively reduce oxidation and corrosion of the magnetic metal powder 22.

A second preferable substance constituting the coating layer 24 is a substance containing a functional group on the surface of the coating layer in order to improve binding to the biological substance. Examples of the functional group that improves the binding include, depending on a target substance, an OH group, a COOH group, an NH₂ group, an epoxy group, a trimethylsilyl group, and an NHS group.

Other examples of preferable substances constituting the coating layer 24 include proteins such as streptavidin, Protein A, and Protein B, and carbon. In addition, when a nucleic acid is to be extracted, examples of preferable substances include a nucleic acid having a property complementary to the target nucleic acid, specifically, an oligo (dT) primer cDNA. Further, in the case of cell separation or exosome separation, examples of preferable substances include antibodies such as CD3, CD4, CD8, CD9, CD63, and CD81.

It is desirable that the coating layer 24 does not capture any substance that is not the extraction target, such as impurities. From this viewpoint, the coating layer 24 preferably contains a substance called a blocking substance together with the above-described preferable substances of the coating layer 24. Examples of the blocking substance include polyethylene glycol, albumin, and dextrin.

The coating layer 24 may contain a substance (impurities) other than the oxide, within a range in which the effects are not impaired, for example, in a ratio of 50% by mass or less relative to the oxide described above. For example, when a silicon oxide is used as the oxide, examples of the impurities include C, N, and P.

A composition of the oxide can be determined by, for example, EDX analysis or Auger electron spectroscopy measurement.

A structure of the coating layer 24 may be any one of a single layer composed of a single substance, a single layer composed of a plurality of substances, composites, or mixtures, or a structure formed of a plurality of layers having different compositions in a depth direction of the magnetic bead 2. In addition, the surface of the coating layer 24 may be formed of a single substance or a plurality of substances.

The average thickness t of the coating layer 24 is preferably 10 nm or more and 200 nm or less, more preferably 20 nm or more and 150 nm or less, and still more preferably 30 nm or more and 100 nm or less. Accordingly, even when the magnetic beads 2 collide with each other or collide with the inner wall of the container or the like, the coating layer 24 can be prevented from being broken or peeled off. As a result, it is possible to prevent a decrease in extraction efficiency of the biological substance and generation of impurities when the biological substance is taken out. In addition, it is possible to reduce elution of iron ions and the like due to exposure of the magnetic metal powder 22. Further, it is possible to prevent a decrease in magnetization per volume of the magnetic bead 2 and to prevent a decrease in moving speed of the magnetic bead 2.

FIG. 6 is a cross-sectional view showing a modification of the magnetic bead 2 in FIG. 5.

In FIG. 6, a magnetic bead 2A according to the modification contains a plurality of magnetic metal powders 22 in one particle. That is, a plurality of particles of the magnetic metal powder 22 are aggregated, and the coating layer 24 is provided so as to cover the aggregate. In such a magnetic bead 2A, the same effects as those of the magnetic bead 2 can still be obtained.

The number of particles of the magnetic metal powder 22 provided in the magnetic bead 2A is not particularly limited, and may be 2 or more and 100 or less.

### 2.3. Effects of Magnetic Bead According to Embodiment

As described above, the magnetic bead 2 according to the embodiment contains the magnetic metal powder 22 (Fe-based magnetic metal powder) in which the Fe content is highest in terms of atomic ratio, and the coating layer 24 with which the particle surface of the magnetic metal powder 22 is coated. The magnetic metal powder 22 contains the crystal grain having a grain diameter of 1 nm or more and 60 nm or less in a ratio of 30% by volume or more and 100% by volume or less. That is, the magnetic metal powder 22 is a powder containing, at the predetermined volume ratio, the nanocrystal whose grain diameter is in the predetermined grain diameter range.

Since such a magnetic bead 2 has a low coercive force and high saturation magnetization derived from the nanocrystal, the magnetic bead 2 has excellent magnetic separation performance, for example, when used in a biological substance extraction method using magnetic separation. That is, since the magnetic bead 2 efficiently adsorbs the biological substance and has excellent solid-liquid separation performance, the magnetic bead 2 contributes to efficient extraction of a high-purity biological substance. In addition, by containing the nanocrystal, corrosion resistance of the magnetic bead 2 can be improved. Accordingly, the elution of iron ions from the magnetic metal powder 22 can be reduced. Further, by providing the coating layer 24 with which the particle surface of the magnetic metal powder 22 is coated, the elution of iron ions can be further reduced. As a result, it is possible to prevent a decrease in adsorption efficiency of the biological substance caused by the iron ions and to prevent the iron ions from being brought into testing, and thus it is possible to improve testing accuracy of the extracted biological substance.

In addition, the magnetic metal powder 22 may be composed of the alloy having the composition represented by the composition formula Fe_{100-a-b-c-d-e}CuₐSi_{b}B_{c}Nb_{d}Mₑ. M in the composition formula is V, Cr, Mn, Al, a platinum group element, Sc, Y, Au, Zn, Sn, or Re, and a, b, c, d, and e represent an atomic percentage of each element. In addition, in the composition formula, 0≤a≤3.0, 0<b≤30.0, 0≤c≤25.0, 0≤d≤30.0, and 0≤e≤10.0.

Such a Fe-based alloy is particularly excellent in low coercive force and high saturation magnetization.

In addition, in the magnetic bead 2 according to the embodiment, the coating layer 24 preferably contains an oxide and has an average thickness of 10 nm or more and 200 nm or less.

Such a magnetic bead 2 is particularly excellent in resistance in an acidic solution, and can effectively reduce oxidation and corrosion of the magnetic metal powder 22. Accordingly, even when the magnetic bead 2 is used for biological substance extraction in an acidic solution, elution of iron ions can be reduced, and thus a decrease in testing accuracy of the biological substance due to the iron ions can be prevented.

In addition, the oxide contained in the coating layer 24 may be a silicon oxide. The silicon oxide is a substance particularly suitable for extraction of nucleic acids such as DNA and RNA, and enables efficient extraction and collection of the nucleic acids by specifically adsorbing the nucleic acids in an aqueous solution containing a chaotropic substance.

In addition, the average particle diameter of the magnetic bead 2 may be 0.1 μm or more and 100 μm or less. Accordingly, the specific surface area of the magnetic bead 2 can be sufficiently large, and the mass and saturation magnetization of the magnetic bead 2 are suitable for magnetic separation. As a result, it is possible to obtain the magnetic bead 2 which has a specific surface area enabling adsorption of a sufficient amount of the biological substance and exhibit a magnetic attractive force excellent in separation performance in magnetic separation. In addition, aggregation of the magnetic beads 2 can be reduced, and thus dispersibility can be improved.

### 3. Method for Producing Magnetic Bead

Next, the method for producing the magnetic bead according to the embodiment will be described.

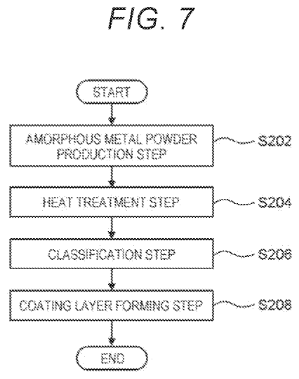

FIG. 7 is a process diagram showing the method for producing the magnetic bead according to the embodiment. Although the magnetic bead 2 described above is not limited to be produced by the following production method, for convenience of description, production of the magnetic bead 2 will be described.

The method for producing the magnetic bead 2 shown in FIG. 7 includes an amorphous metal powder production step S202, a heat treatment step S204, a classification step S206, and a coating layer forming step S208. Hereinafter, each step will be described. In the amorphous metal powder production step S202, a Fe-based amorphous metal powder for producing the magnetic metal powder 22 is produced. In the heat treatment step S204, the Fe-based amorphous metal powder is subjected to a heat treatment to precipitate a nanocrystal in a particle. In the classification step S206, the magnetic metal powder 22 is classified so as to have a predetermined particle diameter and a predetermined particle diameter distribution. In the coating layer forming step S208, the coating layer 24 is formed on the particle surface of the magnetic metal powder 22 subjected to the classification step. Hereinafter, each step will be described.

### 3.1. Amorphous Metal Powder Production Step

In the amorphous metal powder production step S202, a Fe-based amorphous metal powder having a non-crystal structure (amorphous structure) is produced. Examples of a production method thereof include a melting process in which a metal is melted and solidified to form a powder, and a mechanical process in which a larger-shaped product such as an ingot is mechanically pulverized to obtain a powder. Among these, the Fe-based amorphous metal powder used in the production of the magnetic metal powder 22 is suitably produced by the melting process.

Among production methods based on the melting process, an atomization method is exemplified as a representative production method. In this method, a molten metal having a desired composition formed by melting is sprayed so as to form a powder.

The atomization method is a method in which a molten metal is rapidly solidified by colliding with a fluid (liquid or gas) injected at a high speed so as to form a powder. The atomization method is divided into a water atomization method, a rotary water atomization method, a gas atomization method, and the like depending on a type of a cooling medium or a difference in device configurations. By producing the metal powder by such an atomization method, the Fe-based amorphous metal powder can be efficiently produced. In addition, in the atomization method, a particle shape of the metal powder is close to a spherical shape due to an action of surface tension.

In the embodiment, the molten metal is cooled at an extremely high cooling rate of about 103° C./sec to 107° C./sec by using the water atomization method or the rotary water atomization method. Accordingly, it is possible to solidify the molten metal in a state in which disordered atomic arrangement in the molten metal is highly maintained. Therefore, the Fe-based amorphous metal powder can be efficiently produced. In addition, the Fe-based amorphous metal powder produced in this way contains an oxide film having an appropriate thickness on the particle surface due to contact with water. This oxide film can serve as a base for forming the coating layer 24. That is, by attaching the oxide film, a film forming property of the coating layer 24 can be improved, a coverage of the coating layer 24 can be easily increased, and adhesion between the magnetic metal powder 22 and the coating layer 24 can be improved.

### 3.2. Heat Treatment Step

In the heat treatment step S204, the magnetic metal powder 22 containing the nanocrystal can be obtained by subjecting the amorphous metal powder to an appropriate heat treatment.

A temperature in the heat treatment is 520° C. or higher and 640° C. or lower, preferably 560° C. or higher and 630° C. or lower, and more preferably 570° C. or higher and 620° C. or lower. By setting the temperature in the heat treatment within the above range, nanocrystals having a more uniform grain diameter can be formed. Accordingly, it is possible to implement a lower coercive force and higher saturation magnetization of the magnetic bead 2 that contains the magnetic metal powder 22.

When the temperature in the heat treatment is lower than the lower limit value, depending on the composition of the Fe-based alloy or the like, the nanocrystal may not be sufficiently formed and the volume ratio of the nanocrystal may be insufficient. On the other hand, when the temperature in the heat treatment exceeds the upper limit value, coarse crystals may be increased.

In addition, as for a time in the heat treatment, a time during which the temperature described above is maintained is preferably 1 minute or longer and 180 minutes or shorter, more preferably 3 minutes or longer and 120 minutes or shorter, and still more preferably 5 minutes or longer and 60 minutes or shorter. By setting the time in the heat treatment within the above range, nanocrystals having a more uniform grain diameter can be formed.

A heating rate in the heat treatment is preferably 10° C./min or more and 35° C./min or less, more preferably 10° C./min or more and 30° C./min or less, and still more preferably 15° C./min or more and 25° C./min or less. By setting the heating rate within the above range, the grain diameter of the crystal grain and the volume ratio of the nanocrystal can be easily controlled within the above range regardless of the composition of the Fe-based alloy.

A cooling rate in the heat treatment is preferably 40° C./min or more and 80° C./min or less, more preferably 50° C./min or more and 70° C./min or less, and still more preferably 55° C./min or more and 65° C./min or less. By setting the cooling rate within the above range, the grain diameter of the crystal grain and the volume ratio of the nanocrystal can be easily controlled within the above range regardless of the composition of the Fe-based alloy.

An atmosphere in the heat treatment is not particularly limited, and is preferably an inert gas atmosphere such as nitrogen or argon, a reducing gas atmosphere such as hydrogen or ammonia decomposition gas, or a reduced-pressure atmosphere of such gases. Accordingly, it is possible to crystallize the metal while reducing oxidation of the metal along with the heat treatment, and thus it is possible to obtain the magnetic metal powder 22 having excellent magnetic properties.

After the magnetic metal powder 22 is produced as described above, the classification step is performed as necessary, and then the coating layer forming step is performed. An order of the classification step and the coating layer forming step may be reversed, or an order of the heat treatment step and the classification step may be reversed.

### 3.3. Classification Step

In the classification step S206, the magnetic metal powder 22 obtained in the heat treatment step S204 is classified to adjust the particle diameter and the particle diameter distribution.

Examples of a classification method thereof include a method using a sieve, a method using a moving distance difference caused by a centrifugal force in a fluid such as air or water, and a method using a settling velocity difference caused by gravity in a fluid (gravity classification). In addition, as for classification in a fluid, a method of classifying in a gas such as air is generally referred to as dry classification (wind classification), and a method of classifying in a liquid such as water is generally referred to as wet classification. Classification by a so-called cyclone method, a rotor method, or the like using the moving distance difference caused by the centrifugal force is used in both dry classification and wet classification, and the classification in a liquid is more preferable from the viewpoint of improving dispersibility in a fluid and reducing aggregation of particles.

### 3.4. Coating Layer Forming Step

In the coating layer forming step S208, the coating layer 24 is formed on the particle surface of the magnetic metal powder 22. A method for forming the coating layer 24 is not particularly limited, and examples thereof include a wet forming method such as a sol-gel method and a coupling agent treatment, and a dry forming method such as an atomic layer deposition (ALD) method, a chemical vapor deposition (CVD) method, and ion plating. Among these methods, in the formation of the coating layer 24 composed of the oxide material, the Stober method that is one of a sol-gel method, or the above-described ALD method can be mainly used.

The Stober method is a method of forming a monodisperse particle by hydrolysis of a metal alkoxide. When the coating layer 24 is formed of a silicon oxide, the coating layer 24 can be formed by a hydrolysis reaction of a silicon alkoxide.

Specifically, first, the magnetic metal powder 22 is dispersed in an alcohol solution containing a silicon alkoxide. Examples of the alcohol solution include lower alcohols such as ethanol and methanol. An addition ratio of the alcohol to the silicon alkoxide may be 10 parts by weight or more and 50 parts by weight or less with respect to 1 part by weight of, for example, tetraethoxysilane. In addition, an addition ratio of the silicon alkoxide to the magnetic metal powder 22 may be 0.01 parts by weight or more and 0.1 parts by weight or less when an amount of the magnetic metal powder 22 is 1 part by weight.

Examples of the silicon alkoxide include tetramethoxysilane (TMOS), tetraethoxysilane (TEOS), tetraisopropoxysilane, tetrapropoxysilane, tetrakis(trimethylsilyloxy)silane, tetrabutoxysilane, tetraphenoxysilane, and tetrakis(2-ethylhexyloxy)silane. As the silicon alkoxide, TEOS is particularly preferably used.

Next, aqua ammonia is supplied as a catalyst for promoting a reaction so as to cause hydrolysis. Accordingly, a dehydration condensation reaction occurs between hydrolysates or between the hydrolysate and the silicon alkoxide, and a —Si—O—Si— bond is formed on the particle surface, thereby forming a silicon oxide film.

Before and after the aqua ammonia is supplied, the magnetic metal powder 22 and the alcohol solution are preferably stirred by using an ultrasonic wave applying device or the like. By performing stirring in each step in this way, uniform dispersion of particles can be promoted, and the silicon oxide film can be uniformly formed on the particle surface. The stirring is preferably performed for a period of time longer than a period of time during which the hydrolysis reaction of the silicon alkoxide sufficiently proceeds.

In addition, although the magnetic metal powder 22 is dispersed in the alcohol solution containing the silicon alkoxide and then the aqua ammonia is supplied in the above description, the order is not limited thereto. For example, the alcohol solution containing the silicon alkoxide may be mixed after the aqua ammonia is mixed with the alcohol solution in which the magnetic metal powder 22 is dispersed. In such a case, the alcohol solution containing the silicon alkoxide may be added several times. In the case where the alcohol solution is added several times, the above-described stirring may be performed each time the alcohol solution is added, or the alcohol solution may be added to the solution under stirring.

As a material having the same effect as that of the aqua ammonia, triethylamine, triethanolamine, or the like may be used.

In addition, when the thickness of the coating layer 24 is to be adjusted, a ratio of the silicon alkoxide in the solution may be appropriately changed. For example, the thickness of the coating layer 24 is increased by increasing the ratio of the silicon alkoxide in the solution.

The magnetic beads 2 are obtained by the above steps, and a heat treatment may be applied to the obtained magnetic bead 2 in order to further improve performance thereof. For example, by heating at a temperature of 60° C. or higher and 300° C. or lower for 10 minutes or longer and 300 minutes or shorter, it is possible to remove a hydrate remaining in the magnetic bead 2 and to improve strength of the magnetic bead 2. In addition, under this heat treatment condition, coarsening of crystal grains and the like can be prevented.

Meanwhile, the ALD method is also a method suitable for forming the silicon oxide coating film. Specific methods for forming the silicon oxide coating film by the ALD method include a method in which the magnetic metal powder 22 is charged into a chamber enabling vacuuming and controlling an atmosphere, a substance called a precursor for forming the silicon oxide film is charged into the chamber, and then the precursor is thermally decomposed to form a silicon oxide on the particle surface of the magnetic metal powder 22. Examples of the precursor include dimethylamine, methylethylamine, diethylamine, trisdimethylaminosilane, bisdiethylaminosilane, and bistertiarybutylaminosilane. According to the ALD method, it is possible to form the coating layer 24 that is dense and thin by depositing a raw material at an atomic layer level.

In addition, by selecting the precursor, it is possible to form an oxide layer other than the silicon oxide layer or a coating layer composed of a composite oxide.

### 3.5. Effects of Method for Producing Magnetic Bead According to Embodiment

As described above, the method for producing the magnetic bead according to the embodiment is a method for producing the magnetic metal powder 22 (Fe-based magnetic metal powder), and includes the amorphous metal powder production step S202 and the heat treatment step S204. In the amorphous metal powder production step S202, the Fe-based amorphous metal powder is produced by the water atomization method or the rotary water atomization method. In the heat treatment step S204, the Fe-based amorphous metal powder is subjected to the heat treatment at a temperature of 520° C. or higher and 640° C. or lower, and a crystal grain (nanocrystal) having a grain diameter of 1 nm or more and 60 nm or less is precipitated in a ratio of 30% by volume or more and 100% by volume or less.

According to the method for producing the magnetic bead including these steps, after the Fe-based amorphous metal powder is produced, the nanocrystal is precipitated by the heat treatment. Therefore, the grain diameter of the nanocrystal is more uniform, and the volume ratio is easily increased. Therefore, according to the present production method, for example, the magnetic bead 2 described above can be efficiently produced. In addition, since a structure other than the nanocrystal is likely to be an amorphous structure, it is possible to produce the magnetic bead 2 that exhibits effects by coexistence of the amorphous structure and the nanocrystal.

Although the magnetic bead and the method for producing the magnetic bead according to the present disclosure are described above based on the illustrated embodiment, the present disclosure is not limited thereto. For example, the magnetic bead according to the present disclosure may be a bead in which any component is added to the above-described embodiment. In addition, in the method for producing the magnetic bead according to the present disclosure, a step of any purpose may be added to the above embodiment.

### EXAMPLES

Next, specific examples of the present disclosure will be described.

### 4. Preparation of Magnetic Bead

### 4.1. Example 1

First, a raw material having a composition shown in Table 1 was melted and pulverized by a rotary water atomization method to obtain an amorphous metal powder. Next, the amorphous metal powder was subjected to a heat treatment in a nitrogen atmosphere. Accordingly, a magnetic metal powder was obtained. Conditions in the heat treatment are as shown in Table 1. In addition, when a metal structure analysis of the obtained magnetic metal powder was performed by an X-ray diffraction method, it was determined that a main structure was a nanocrystal. Specifically, since a diffraction pattern obtained by the X-ray diffraction method included a diffraction peak and a line width of the diffraction peak was wider than a standard line width of a coarse crystal, it was found that both the nanocrystal and a slight amorphous structure were contained. Then, a particle cross section was observed with a transmission electron microscope, and a volume ratio of the nanocrystal was measured. The measured volume ratio of the nanocrystal was 30% by volume or more, and thus the volume ratio is listed as “A” in Table 1 in light of evaluation criteria to be described later.

Next, the obtained magnetic metal powder was classified, and then a silicon oxide (SiO₂) film was formed on a particle surface of the magnetic metal powder by the Stober method so as to obtain a magnetic bead. An average particle diameter of the magnetic bead and an average thickness of the coating layer are as shown in Table 1.

### 4.2. Examples 2 to 8 and Comparative Examples 1 to 10

Magnetic beads were obtained in the same manner as in Example 1 except that a composition of a raw material, production conditions of magnetic beads, and characteristics of magnetic beads were as shown in Table 1. The volume ratio of the nanocrystal was evaluated in light of the following evaluation criteria.
A: the volume ratio of the nanocrystal is 30% by volume or more and 100% by volume or less
B: the volume ratio of the nanocrystal is less than 30% by volume, and a main metal structure is a coarse crystal
C: the volume ratio of the nanocrystal is less than 30% by volume, and the main metal structure is an amorphous structure

### 5. Evaluation of Magnetic Bead

### 5.1. Saturation Magnetization

Saturation magnetization of the magnetic bead in each of Examples and Comparative Examples was measured. Then, the measured saturation magnetization was evaluated in light of the following evaluation criteria.
A: the saturation magnetization is 140 emu/g or more
B: the saturation magnetization is 100 emu/g or more and less than 140 emu/g
C: the saturation magnetization is less than 100 emu/g

Evaluation results are shown in Table 1.

### 5.2. Coercive Force

A coercive force of the magnetic bead in each of Examples and Comparative Examples was measured. Then, the measured coercive force was evaluated in light of the following evaluation criteria.
A: the coercive force is 400 A/m or less
B: the coercive force is more than 400 A/m and 1500 A/m or less
C: the coercive force is more than 1500 A/m

Evaluation results are shown in Table 1.

### 5.3. Corrosion Resistance

The magnetic bead in each of Examples and Comparative Examples was added to a hydrochloric acid having a pH of 2.5 to prepare a magnetic bead dispersion. Next, the magnetic bead dispersion was allowed to stand for 30 minutes, and then the magnetic bead was taken out. Next, a weight concentration of iron ions in the remaining dispersion medium was measured by phenanthroline absorption spectrophotometry. Then, the measured weight concentration of iron ions was evaluated in light of the following evaluation criteria.
A: the weight concentration of iron ions is less than 1 ppm
B: the weight concentration of iron ions is 1 ppm or more and less than 2 ppm
C: the weight concentration of iron ions is 2 ppm or more and less than 5 ppm
D: the weight concentration of iron ions is 5 ppm or more

Evaluation results are shown in Table 1.

TABLE 1

| | Production condition and characteristic of magnetic bead | | | | | | | | | | | | |
|---|---|---|---|---|---|---|---|---|---|---|---|---|---|
| | | | | | | | | Volume ratio | Average particle | Average | Evaluation result of magnetic bead | | |
| | Composition | | | | | | Heat | of | magnetic bead | coating layer | Saturation | Coercive | Corrosion |
| | Cu | Si | B | Nb | Cr | Fe | treatment | nanocrystal | diameter of | thickness of | magnetization | force | resistance |
| | Atom % | | | | | | — | — | μm | nm | — | — | — |
| Example 1 | 1.3 | 8.0 | 2.0 | 6.0 | 0.0 | Rest | Yes | A | 5 | 30 | A | A | A |
| Example 2 | 1.3 | 8.0 | 2.0 | 6.0 | 0.0 | Rest | Yes | A | 5 | 10 | A | A | 8 |
| Comparative | 1.3 | 8.0 | 2.0 | 6.0 | 0.0 | Rest | Yes | A | 5 | 0 | A | A | C |
| Example 1 | | | | | | | | | | | | | |
| Comparative | 1.3 | 8.0 | 2.0 | 6.0 | 0.0 | Rest | No | C | 5 | 10 | B | A | C |
| Example 2 | | | | | | | | | | | | | |
| Example 3 | 1.0 | 13.0 | 10.0 | 3.0 | 0.0 | Rest | Yes | A | 3 | 30 | A | A | A |
| Example 4 | 1.0 | 13.0 | 10.0 | 3.0 | 0.0 | Rest | Yes | A | 3 | 10 | A | A | B |
| Comparative | 1.0 | 13.0 | 10.0 | 3.0 | 0.0 | Rest | Yes | A | 3 | 0 | A | A | C |
| Example 3 | | | | | | | | | | | | | |
| Comparative | 1.0 | 13.0 | 10.0 | 3.0 | 0.0 | Rest | No | C | 3 | 30 | B | A | C |
| Example 4 | | | | | | | | | | | | | |
| Example 5 | 0.8 | 15.0 | 8.0 | 5.0 | 0.5 | Rest | Yes | A | 10 | 30 | A | | A |
| Example 6 | 0.8 | 15.0 | 8.0 | 5.0 | 0.5 | Rest | Yes | A | 10 | 10 | | A | A |
| Comparative | 0.8 | 15.0 | 8.0 | 5.0 | 0.5 | Rest | Yes | A | 10 | 0 | A | A | C |
| Example 5 | | | | | | | | | | | | | |
| Comparative | 0.8 | 15.0 | 8.0 | 5.0 | 0.5 | Rest | No | C | 10 | 10 | B | A | C |
| Example 6 | | | | | | | | | | | | | |
| Example 7 | 0.5 | 6.0 | 11.0 | 1.0 | 2.0 | Rest | Yes | A | 15 | 30 | A | A | A |
| Example 8 | 0.5 | 6.0 | 11.0 | 1.0 | 2.0 | Rest | Yes | A | 15 | 10 | A | A | A |
| Comparative | 0.5 | 6.0 | 11.0 | 1.0 | 2.0 | Rest | Yes | A | 15 | 0 | A | A | C |
| Example 7 | | | | | | | | | | | | | |
| Comparative | 0.5 | 6.0 | 11.0 | 1.0 | 2.0 | Rest | No | C | 15 | 10 | B | A | C |
| Example 8 | | | | | | | | | | | | | |
| Comparative | 0.0 | 5.0 | 0.0 | 0.0 | 2.5 | Rest | No | B | 5 | 30 | A | C | C |
| Example 9 | | | | | | | | | | | | | |
| Comparative | 0.0 | 5.0 | 0.0 | 0.0 | 2.5 | Rest | No | B | 5 | 10 | Å | C | D |
| Example 10 | | | | | | | | | | | | | |

As shown in Table 1, the magnetic bead in each Example had a low coercive force and high saturation magnetization. In addition, the magnetic bead in each Example had a small elution amount of iron ions and also had good corrosion resistance. Therefore, it is presumed that when the magnetic bead according to the present disclosure is used for extraction of a biological substance, the magnetic bead can contribute to improvement of testing accuracy of the extracted biological substance.

On the other hand, the magnetic bead in each of Comparative Example 1, Comparative Example 3, Comparative Example 5, and Comparative Example 7 had no coating layer, so that the elution amount of iron ions was large and the corrosion resistance was not sufficient.

In addition, the magnetic bead in each of Comparative Example 2, Comparative Example 4, Comparative Example 6, and Comparative Example 8 were not subjected to a heat treatment, and thus the volume ratio of the nanocrystal was low, and the main metal structure was an amorphous structure. Therefore, the saturation magnetization and the corrosion resistance were low.

Further, since the magnetic bead in each of Comparative Examples 9 and 10 had a composition in which an alloy composition was not easily amorphized, a coarse crystal was precipitated, and the volume ratio of the nanocrystal was low. Therefore, even though the coating layer is provided, the elution amount of iron ions was large, and the corrosion resistance was low.

The same experiment as described above was performed by replacing a constituent material of the coating layer from a single layer of a silicon oxide to a multilayer of a silicon oxide/aluminum oxide. As a result, the same tendency as in the case of the silicon oxide was observed.

What is claimed is:

1. A magnetic bead comprising:
a Fe-based magnetic metal powder; and
a coating layer with which a particle surface of the Fe-based magnetic metal powder is coated, wherein
the Fe-based magnetic metal powder contains a crystal grain having a grain diameter of 1 nm or more and 60 nm or less in a ratio of 30% by volume or more and 100% by volume or less.

2. The magnetic bead according to claim 1, wherein
the Fe-based magnetic metal powder contains an alloy having a composition represented by a composition formula Fe_{100-a-b-c-d-e}CuₐSi_{b}B_{c}Nb_{d}Mₑ,
M in the composition formula is V, Cr, Mn, Al, a platinum group element, Sc, Y, Au, Zn, Sn or Re,
a, b, c, d, and e represent an atomic percentage of each element, and
in the composition formula,
0≤a≤3.0,
0<b≤30.0,
0≤c≤25.0,
0≤d≤30.0, and
0≤e≤10.0.

3. The magnetic bead according to claim 1, wherein
the coating layer contains an oxide and has an average thickness of 10 nm or more and 200 nm or less.

4. The magnetic bead according to claim 3, wherein
the oxide is a silicon oxide.

5. The magnetic bead according to claim 1, wherein
the magnetic bead has an average particle diameter of 0.1 μm or more and 100 μm or less.

6. A method for producing a magnetic bead containing a Fe-based magnetic metal powder, the method comprising:
producing a Fe-based amorphous metal powder by a water atomization method or a rotary water atomization method; and
subjecting the Fe-based amorphous metal powder to a heat treatment at a temperature of 520° C. or higher and 640° C. or lower to precipitate a crystal grain having a grain diameter of 1 nm or more and 60 nm or less in a ratio of 30% by volume or more and 100% by volume or less.
